(19) United States
(12) Patent Application Publication
(10) Pub. No.: US 2004/0252952 A1
(43) Pub. Date: Dec. 16, 2004

(54) Coupling of optical components in an optical subassembly

(76) Inventors: Michael H. Ayliffe, San Jose, CA (US); Diana Chen, San Jose, CA (US)

Correspondence Address: ROBERT A. PARSONS, 340 E. PALM LN, SUITE 260, PHOENIX, AZ, 85004, US

(21) Appl. No.: 10/721,197

(22) Filed: Nov. 25, 2003

Related U.S. Application Data
(60) Provisional application No. 60/431,246, filed on Dec. 5, 2002.

(51) Int. Cl. G02B 6/36

(52) U.S. Cl. 385/92

(57) ABSTRACT

Coupled-power adjusting apparatus is disclosed in conjunction with optoelectronic modules. The apparatus includes a receptacle assembly with an elongated optical fiber receiving opening having a longitudinal axis and an optoelectronic device. Variable optical power coupling apparatus is mounted in the optical fiber receiving opening and rotateable about the longitudinal axis without moving along the longitudinal axis. Relative rotation of the variable optical power coupling apparatus varies the amount of optical power coupled between the optoelectronic device and an optical fiber positioned in the optical fiber receiving opening. The variable optical power coupling apparatus includes either a polarized isolator or a beveled optical fiber stub.

### CROSS-REFERENCE TO RELATED APPLICATIONS

This application claims the benefit of U.S. Provisional Application No. 60/431,246, filed 5 Dec. 2002.

### FIELD OF THE INVENTION

This invention relates to optical packaging and, more particularly, to apparatus and methods for adjusting the coupled-power in an optical system.

### BACKGROUND OF THE INVENTION

Optoelectronics is a rapidly expanding technology that is an important component in modern communications systems wherein it is desired to transmit vast amounts of data over relatively long distances in a short period of time. With the increasing commercial applications for optoelectronic systems, there is a need to develop cost effective and precise manufacturing techniques for assembling optoelectronic modules (e.g., optical subassemblies, fiber-optic cable repeaters, transmitters, etc.).

Transmitters used in optical fiber communications systems typically require a package containing a semiconductor laser coupled to an optical fiber that extends from the package. A major challenge in constructing such transmitters is in achieving and maintaining optimal alignment of the laser with the optical fiber such that a desired part of the laser output can be transmitted through the fiber. The laser output transmitted through the fiber has a launched power (hereinafter referred to as “P_{launch}”). A common approach is “active alignment” in which, for example, the laser is bonded to a substrate, and the optical fiber is incrementally moved until a desired part (generally maximum coupling) of the laser output is directed through the fiber, whereupon the optical fiber is permanently bonded. Alternatively, the fiber can be first bonded to the substrate, with the laser being moved into alignment and then bonded.

Another problem associated with developing cost-effective techniques for assembling optoelectronic modules at the required high level of precision is achieving dimensional stability during bonding of the optoelectronic device and optical fiber to the substrate. Conventional bonding processes, such as laser welding and epoxy bonding, frequently result in residual stresses in the bonds that may cause undesirable creep and misalignment between the components of the optoelectronic module.

Solder alloys are widely used in the optoelectronics industry for bonding optoelectronic devices to submounts inside optoelectronic package housings. Some of the more common submount materials include aluminum nitride, beryllium oxide, beryllium-copper alloy, copper, copper-tungsten alloy, diamond, molybdenum, silicon, or the like. Because most optoelectronic devices are made from Group III-V (e.g., GaAs, InP, etc.) and their ternary and quaternary alloys (e.g., GalnAs, GalnAsP, GaInAsP, etc.), the submount materials upon which the optoelectronic devices are bonded generally have dissimilar mechanical and thermal properties. In environments where temperature cycling is expected (e.g., commercial aerospace platforms and outdoor fiber-optic cable systems), high thermal stresses and creep strains may build up in the solder joints, potentially leading to premature joint failure and shortened operating life.

Still another problem that arises in optoelectronic devices is the standardization of components and optical packages. As an example, laser characteristics can vary widely, even in a common manufactured batch. Therefore, in a manufacturing environment P_{launch} can vary greatly from transmitter to the next. Some typical examples of characteristics that may affect P_{launch} are: laser characteristics (e.g. far-field pattern, astigmatism, etc.); various differences introduced during assembly (e.g. misalignments of parts, tolerance differences, etc.); polarization loss through isolators; etc. It is desirable to control P_{launch}, especially for a transmitter (i.e. electrical-to-optical module), for two major reasons: industry standards such as SONET, 10 Gigabit Ethernet, Fibre Channel, etc. specify an allowable range of launched power (P. For example, Telcordia GR-253 specifies the allowable range for SONET OC-192 SR-1 to be from −6 to −1 dBm. In general, manufacturers will want to set P_{launch} approximately to the middle of the allowable range (−3.5 dBm in the case of OC-192 SR-1). Furthermore, it is also desirable to minimize the variance of the statistical distribution of P_{launch} over a population of transmitters because this improve transmitter yields and makes design of associated electronics easier.

A standard prior art way to adjust launched power is to design the optical modules with higher coupling efficiency than required and then defocus the light beam along the optical axis (Z-axis) to reduce coupling by the desired amount. The defocusing is generally accomplished by moving the optical fiber along the optical axis. In some optical module designs, especially where the light beam is collimated or almost collimated at the plane of alignment, the sensitivity to defocusing is not high enough. In such cases, the manufacturer needs to change spacing between the laser and an adjacent lens or fiber to defocus the optics. Such a change may be accomplished, for example, by adding spacers. This solution is not desirable in a high-volume manufacturing environment because it requires that P_{launch} be measured and the transmitter be modified with spacers until the target P_{launch} is reached. This process is time consuming and may require that a selection of spacer components be kept in inventory. Further, the use of spacers leads to variations in the module length, if not taken into account in the original design. Accounting for defocusing in the original design can lead to substantial design complexity.

It would be highly advantageous, therefore, to remedy the foregoing and other deficiencies inherent in the prior art.

Accordingly, it is an object the present invention to provide new and improved apparatus and methods for adjusting P_{launch} in optoelectronic modules.

Another object of the present invention is to provide new and improved apparatus and methods for adjusting P_{launch} in optoelectronic modules that are relatively inexpensive to manufacture and is easy to assemble and test.

Another object of the present invention is to provide new and improved apparatus and methods for adjusting P_{launch} in optoelectronic modules that improve the fabrication efficiency and manufacturing capabilities of optoelectronic modules and packages.

Still another object of the present invention is to provide new and improved apparatus and methods for adjusting P_{launch} in optoelectronic modules that allow the use of a variety of optical components and component equipment.

Still another object of the present invention is to provide new and improved apparatus and methods for adjusting P_{launch} in optoelectronic modules that aid in standardizing modules and packages.

### SUMMARY OF THE INVENTION

Briefly, to achieve the desired objects of the instant invention in accordance with a preferred embodiment thereof, P_{launch} adjusting apparatus is disclosed in conjunction with optoelectronic modules. The apparatus includes a receptacle assembly with an elongated optical fiber receiving opening having a longitudinal axis and an optoelectronic device. Variable optical power coupling apparatus is mounted in the optical fiber receiving opening and rotateable about the longitudinal axis without moving along the longitudinal axis. Relative rotation of the variable optical power coupling apparatus varies the amount of optical power coupled between the optoelectronic device and an optical fiber positioned in the optical fiber receiving opening. The variable optical power coupling apparatus includes, preferably, either a polarized isolator or a beveled optical fiber stub.

### BRIEF DESCRIPTION OF THE DRAWING

The foregoing and further and more specific objects and advantages of the instant invention will become readily apparent to those skilled in the art from the following detailed description of a preferred embodiment thereof taken in conjunction with the drawings, in which:

FIG. 1 is a sectional view of an optoelectronic package assembly with an optical isolator in accordance with the present invention;

FIG. 2 is a graph illustrating the P_{launch} as a function of angle for the optoelectronic package illustrated in FIG. 1;

FIG. 3 is a sectional view of the optoelectric package assembly with a beveled optical fiber in accordance with the present invention;

FIG. 4 is an enlarged sectional view of the beveled optical fiber illustrating a high optical power coupling;

FIG. 5 is an enlarged sectional view of the beveled optical fiber illustrating a low optical power coupling; and

FIG. 6 is a graph illustrating the P_{launch} as a function of angle for the optoelectronic package illustrated in FIG. 3.

### DETAILED DESCRIPTION OF THE DRAWINGS

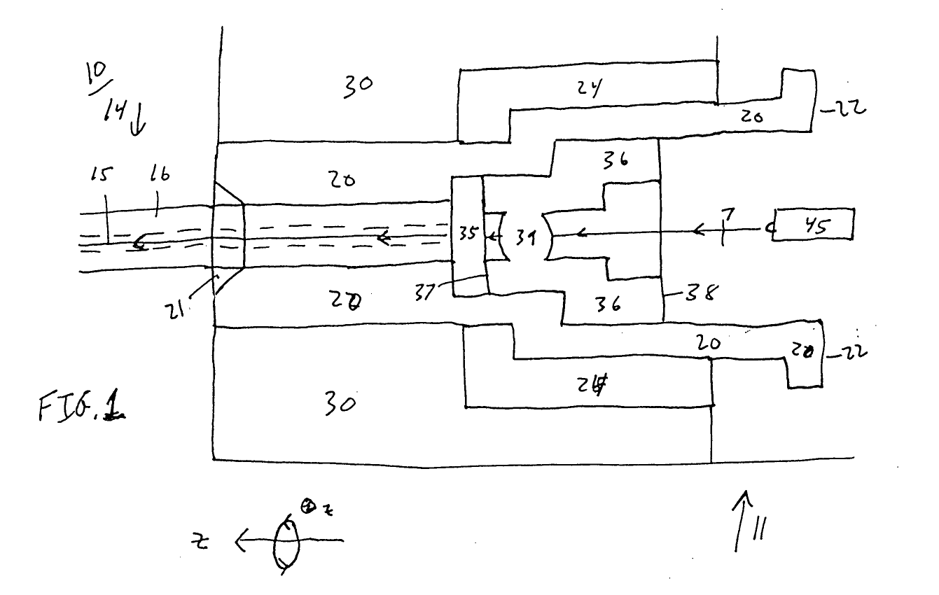

Turning now to FIG. 1, a sectional view is illustrated of either an optical-to-electrical or electrical-to-optical (hereinafter referred to as “optoelectric”) module 10 in accordance with the present invention. It will be understood by those skilled in the art that modules of the type discussed herein generally include a pair of channels, one of which receives electrical signals, converts the electrical signals to optical (light) beams by way of a laser or the like and introduces them into one end of an optical fiber, which then transmits the modulated optical beams to external apparatus. The second channel of the module receives modulated optical beams from an optical fiber connected to the external apparatus, conveys the modulated optical beams to a photodiode or the like, which converts them to electrical signals. In the following description, the apparatus and methods can generally be used in either of the channels, but since the optical portions of the two channels are substantially similar, only one channel will be discussed with the understanding that the description applies equally to both channels.

Module 10 of FIG. 1 includes a receptacle assembly 11 which is designed to receive an optical fiber 14 in communication therewith in a manner that will become clear presently. In the preferred embodiment, optical fiber 14 is a single mode fiber (the use of which is one of the major advantages of the present invention) including a glass core 15 surrounding by a cladding layer (not shown). It will be understood by those skilled in the art that the glass fiber is inserted and bonded to some type of ceramic or glass ferrule 16 or other connection device to add mechanical strength. Receptacle assembly 11 includes an elongated cylindrical receptacle 20 defining a fiber receiving opening 21 at one end and a mounting flange 22 at the opposite end.

Elongated cylindrical receptacle 20 is typically positioned in a mounting housing 30. A sleeve 24 is used to hold ferrule 20 within housing 30 so as to engage receptacle 20 within housing 30 and prevent relative longitudinal movement. Thus, to easily and conveniently mount receptacle 20 in housing 30, receptacle 20 with sleeve 24 engaged thereover is press-fit into the circular opening in housing 30 and frictionally holds receptacle 20 in place. Preferably, sleeve 24 is formed, completely or partially, of some convenient resilient material and may be electrically conductive or non-conductive as required in the specific application.

In this embodiment, an optical isolator 35 is positioned adjacent to the end facet of fiber ferrule 16. Isolator 35 acts to prevent light 7 emitted in a z-direction from a laser 45 from reflecting back into laser 45. In the preferred embodiment, isolator 35 is polarized in an angular direction, θ_{z}. A lens assembly 36 is positioned adjacent to receptacle 20 and isolator 35. In this embodiment, the isolator garnet is latched by pre-applying a magnetic field; this avoids the need of a permanent magnet to be integrated in the receptacle assembly. Lens assembly 36 includes a lens 39 for focusing light 7 emitted by laser 45. In this preferred embodiment, lens assembly 36 is formed of plastic and may be, for example, molded to simplify manufacturing of module 10.

It should be understood that the term “plastic” is used herein as a generic term to describe any non-glass optical material that operates to transmit optical beams of interest therethrough and which can be conveniently formed into lenses and the like. For example, in most optical modules used at the present time the optical beams are generated by a laser that operates in the infrared band and any materials that transmit this light, including some oxides and nitrides, come within this definition. It will be understood, however, that lens assembly 36 may be formed, partially or completely, of glass or other materials with desired optical properties.

Lens assembly 36 defines a central opening for the transmission of light therethrough from an end 37 to an opposite end 38. Lens 39 is integrally formed in the central opening a fixed distance from end 37. Lens assembly 36 is formed with radially outwardly projecting ribs or protrusions in the outer periphery (not shown) so that it can be press-fit into receptacle 20 tightly against isolator 35. Thus, lens assembly 36 is frictionally held in place within receptacle 20 and holds isolator 35 fixedly in place within receptacle 20. Also, lens 39 is spaced a fixed and known distance from isolator 35. In this preferred embodiment, fiber ferrule 16 is inserted into receptacle 20 so that glass core 15 physically contacts against isolator 35. Further, by forming isolator 35 of glass material with an index of refraction similar to the index of refraction of glass core 15, the return reflections of light travelling back from the fiber towards the laser is substantially reduced or supressed.

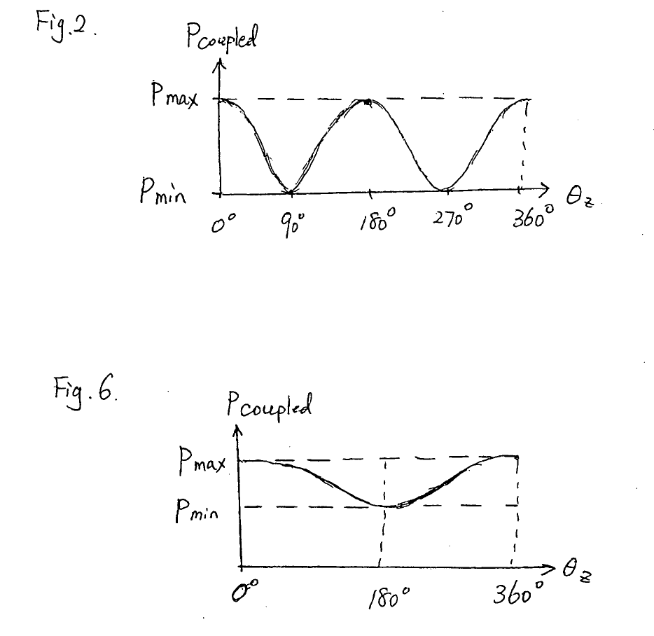

Preferably, P_{launch} is adjusted by rotating ferrule 16 in the θ_{z} direction. The rotation changes the angle of the polarization axis of isolator 35 relative to light 7 emitted by laser 45. The change in P_{launch} is illustrated in FIG. 2 where P_{launch} is at a maximum at approximately θ_{z}=0°, θ_{z}=180° and θ_{z}=360° (i.e. even integer multiples of 90°, for example 0, 2, 4, etc.) and P_{launch} is at a minimum at approximately θ_{z}=90° and θ_{z}=270° (i.e. odd integer multiples of 90°, for example 1, 3, etc.).

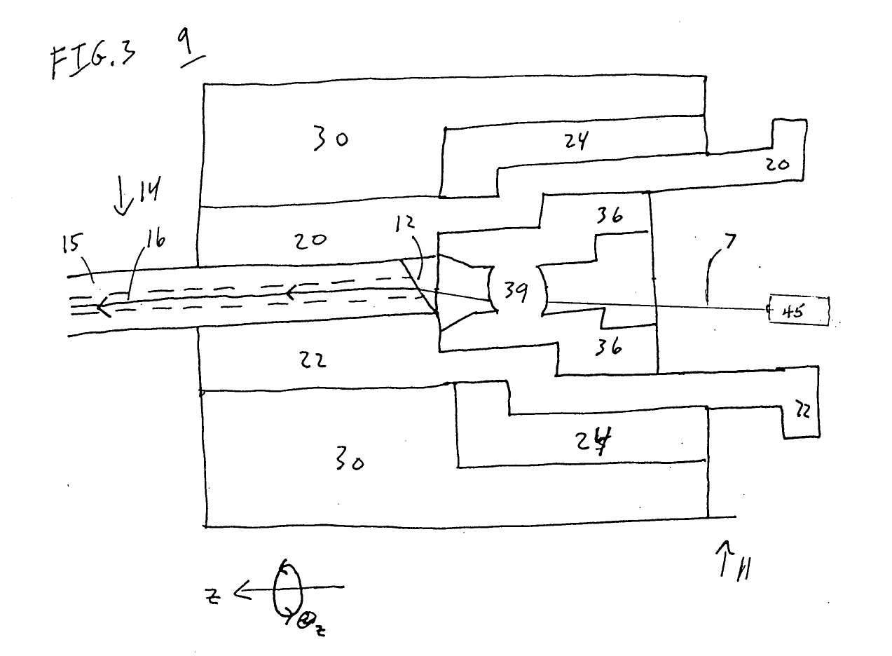

Turn now to FIG. 3 which illustrates another method and apparatus for adjusting P_{launch}. In this embodiment, module 10, as described in conjunction with FIG. 1 including receptacle assembly 11, is designed to receive an optical fiber 14 in communication therewith. However, in this embodiment, isolator 35 is omitted and fiber 14 is beveled at an end 12 adjacent to lens assembly 36. To achieve maximum coupling efficiency, the optical axis of light 7 emitted by laser 45 should be offset laterally relative to the fiber core (See FIG. 4). It will be understood by those skilled in the art that P_{launch} depends on the numerical aperture, NA, of fiber 14 and the bevel can be rotated in θ_{z} to adjust the amount of light 7 coupled into fiber 14. Preferably the rotation is accomplished by rotating ferrule 15 inside receptacle 20 but ferrule 15 but assembly 11 may also be rotated relative to laser 45 if desired.

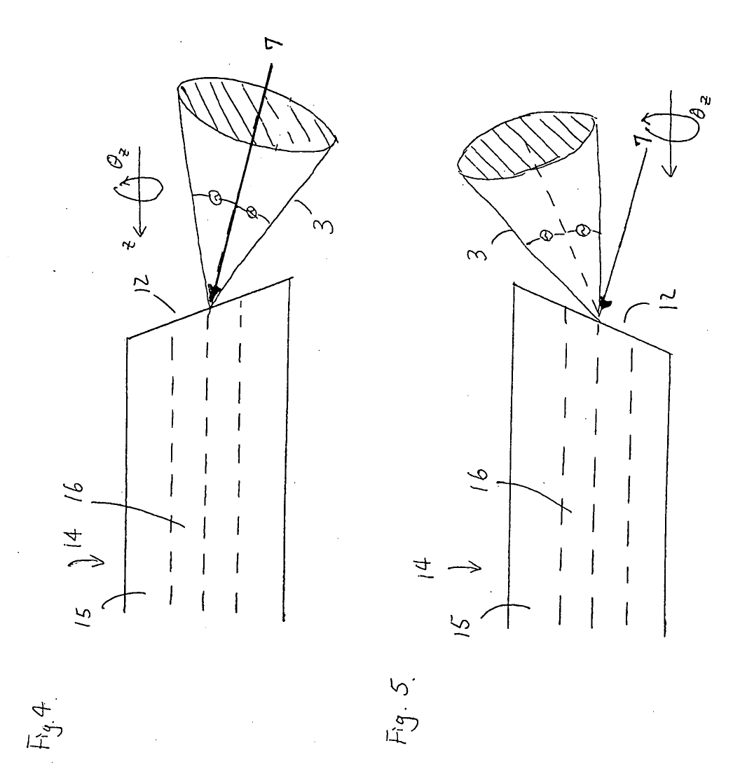

Turn now to FIG. 4 which illustrates an enlarged view of optical fiber 14 and, more particularly, end 12. It will be understood by those skilled in the art that fiber 14 accepts only light rays incident within the numerical aperture. The numerical aperture, as seen in FIG. 4, is defined by a cone 3 having a half-angle, θ, wherein θ is related to the numerical aperture through an equation given as NA=sin(θ). As shown in FIG. 4, in a first rotational orientation of fiber 14, light ray 7 is illustrated to propagate through the center of cone 3 (i.e. most of light 7 impinges within cone 3) so that P_{launch} is maximized. Referring additionally to FIG. 5, in a second rotational orientation of fiber 14, light ray 7 is illustrated to propagate furthest away from the center axis of cone 3 (i.e. most of light 7 impinges outside cone 3) so that P_{launch} is minimized. This result is illustrated graphically in FIG. 6 where P_{launch} is at a maximum at θ_{z}=0° (FIG. 4) and θ_{z}32 360° (FIG. 4) and P_{launch} is at a minimum at θ_{z}=180° (FIG. 5).

It will be understood by those skilled in the art that optical fiber 15, illustrated in FIGS. 4 and 5, preferably is an optical fiber stub that is included as a permanent part of a receptacle assembly 11 and adjusted during manufacture to provide the desired coupling power. Generally, opening 21 in receptacle 20 is sufficiently long to include the optical fiber stub and still receive the end of an optical fiber connected to communicate with external apparatus. A communicating optical fiber is generally cut to but against the end of the optical fiber stub to provide good light communication. It will also be understood that the end of an optical fiber connected to communicate with external apparatus could be sliced at the desired angle and used directly if desired.

Thus, in one embodiment, P_{launch} can be varied by rotating ferrule 16 and polarized isolator 35 at an angle in a direction θ_{z} relative to light 7. In another embodiment, P_{launch} can be varied by forming a bevel in fiber 14 at end 12 such that the P_{launch} of fiber 14 can be varied with θ_{z}. It will be understood that optical module 10 is illustrated for simplicity and ease of discussion and that there are other possible configurations to optically couple an optical fiber to a laser using the described coupled-power apparatus and methods.

Thus, a new and improved apparatus and methods for adjusting P_{launch} in optoelectronic modules have been disclosed. The new and improved apparatus and methods for adjusting P_{launch} in optoelectronic modules are relatively inexpensive to manufacture and is easy to assemble and test. Also, the new and improved apparatus and methods for adjusting P_{launch} in optoelectronic modules improve the fabrication efficiency and manufacturing capabilities of optoelectronic modules and packages since they aid in standardization of components by greatly simplifying standardization of modules and packages. Further, the new and improved apparatus and methods for adjusting P_{launch} in optoelectronic modules allow the use of a variety of optical components and component equipment. The variable optical power coupling apparatus has several advantages over prior art apparatus for varying power. The apparatus can be used for any optical configuration, even those employing collimated light. The variable optical power coupling apparatus of the present invention does not vary the length of the optoelectronic modules, since the rotation does not change the length of the light path. Also, spacers are not needed and, in fact even an isolator is not needed in one embodiment.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. Coupled-power adjusting apparatus in optoelectronic modules comprising:
a receptacle assembly including an elongated optical fiber receiving opening with a longitudinal axis and an optoelectronic device; and
variable optical power coupling apparatus mounted in the optical fiber receiving opening of the receptacle assembly and rotateable about the longitudinal axis without moving along the optical axis, relative rotation of the variable optical power coupling apparatus varying the amount of optical power launch between the optoelectronic device and an optical fiber positioned in the optical fiber receiving opening.

2. Coupled-power adjusting apparatus in optoelectronic modules as claimed in claim 1 wherein the variable optical power coupling apparatus includes a polarized isolator.

3. Coupled-power adjusting apparatus in optoelectronic modules as claimed in claim 2 wherein the polarized isolator is positioned in the optical fiber receiving opening of the receptacle assembly so as to be in abutting engagement with an optical fiber positioned in the optical fiber receiving opening.

4. Coupled-power adjusting apparatus in optoelectronic modules as claimed in claim 2 wherein the optoelectronic device includes a laser mounted to emit light along the longitudinal axis.

5. Coupled-power adjusting apparatus in optoelectronic modules as claimed in claim 4 wherein the polarized isolator is polarized in a θ_{z} direction, where the longitudinal axis is a Z-axis, so that relative rotation changes the polarization of the isolator relative to light emitted by the laser and coupled-power is at a maximum at approximately θ_{z}=0°, 180° and 360° and coupled-power is at a minimum at approximately θ_{z}=90° and 270°.

6. Coupled-power adjusting apparatus in optoelectronic modules as claimed in claim 1 wherein the variable optical power coupling apparatus includes a beveled end of an optical fiber defining a numerical aperture (NA).

7. Coupled-power adjusting apparatus in optoelectronic modules as claimed in claim 6 wherein the beveled end of the optical fiber is formed so that the numerical aperture defines an optical cone external to the optical fiber having a half-angle θ, wherein θ is related to the numerical aperture of the optical fiber through an equation given as NA=sin(θ).

8. Coupled-power adjusting apparatus in optoelectronic modules as claimed in claim 7 wherein the half-angle θ of the optical cone defined by the beveled end of the optical fiber is formed to provide maximum coupled optical power at a rotation θ_{z} equal to one of 0° and 360° and to provide minimum coupled optical power at a rotation θ_{z} equal to 180°.

9. Coupled-power adjusting apparatus in optoelectronic modules as claimed in claim 6 wherein the beveled end of the optical fiber is formed on an optical fiber stub permanently mounted in the optical fiber receiving opening of the receptacle assembly.

10. Coupled-power adjusting apparatus in optoelectronic modules comprising:
a receptacle assembly including an elongated optical fiber receiving opening and a laser mounted to emit light along an optical axis extending axially through the elongated optical fiber receiving opening; and
variable optical power coupling apparatus including a polarized isolator mounted in the optical fiber receiving opening of the receptacle assembly and rotateable about the optical axis without moving along the optical axis, relative rotation of the polarized isolator varying the amount of optical power coupled between the laser and an optical fiber positioned in the optical fiber receiving opening, and the polarized isolator being further positioned in the optical fiber receiving opening of the receptacle assembly so that an end of an optical fiber positioned in the optical fiber receiving opening buts against a surface of the polarized isolator.

11. Coupled-power adjusting apparatus in optoelectronic modules as claimed in claim 10 wherein the polarized isolator is polarized in a θ_{z} direction, where the optical axis is a Z-axis, so that relative rotation changes the polarization of the isolator relative to light emitted by the laser and coupled-power is at a maximum at one of θ_{z}=0°, 180° and 360° and coupled-power is at a minimum at one of θ_{z}=90° and 270°.

12. Coupled-power adjusting apparatus in optoelectronic modules comprising:
a receptacle assembly including an elongated optical fiber receiving opening and a laser mounted to emit light along an optical axis; and
variable optical power coupling apparatus including an elongated optical fiber stub having a longitudinal axis and with a beveled end beveled at an angle to the longitudinal axis defining a numerical aperture through which the fiber stub receives light from the laser, the optical fiber stub being mounted in the optical fiber receiving opening of the receptacle assembly with the longitudinal axis at an angle with the optical axis, the optical fiber stub being rotateable about the longitudinal axis without moving along the longitudinal axis, relative rotation of the optical fiber stub varying the amount of optical power coupled between the laser and the optical fiber stub.

13. Coupled-power adjusting apparatus in optoelectronic modules as claimed in claim 12 wherein the beveled end of the optical fiber is formed so that the numerical aperture defines an optical cone external to the optical fiber having a half-angle θ, wherein θ is related to the numerical aperture of the optical fiber through an equation given as NA=sin(θ).

14. Coupled-power adjusting apparatus in optoelectronic modules as claimed in claim 13 wherein the half-angle θ of the optical cone defined by the beveled end of the optical fiber is formed to provide maximum coupled optical power at a rotation θ_{z} equal to one of 0° and 360° and to provide minimum coupled optical power at a rotation θ_{z} equal to 180°.
